(19) United States
(12) Patent Application Publication
(10) Pub. No.: US 2026/0037169 A1
(43) Pub. Date: Feb. 5, 2026

(54) STORAGE SYSTEM AND OPERATING METHOD THEREOF

(71) Applicant: SK hynix Inc., Gyeonggi-do (KR)

(72) Inventors: Eun Ju YOON, Gyeonggi-do (KR); Dong Hyun CHO, Gyeonggi-do (KR)

(21) Appl. No.: 18/946,918

(22) Filed: Nov. 14, 2024

(30) Foreign Application Priority Data
Jul. 31, 2024 (KR) 10-2024-0102015

(51) Int. Cl. G06F 3/06

(52) U.S. Cl. CPC G06F 3/064; G06F 3/0619; G06F 3/0646; G06F 3/0679

(57) ABSTRACT

A storage device programs a requested data unit into a second memory block by programming the requested data unit into the first memory block corresponding to a logical address included in the request and updating a mapping relationship between a physical address indicating a first memory block and the logical address and moving the programmed data unit to the second memory block. A controller records the logical address and the physical address in a meta data unit corresponding to the requested data unit and verifies integrity of the mapping relationship for the moved data unit.

### CROSS-REFERENCE TO RELATED APPLICATIONS

The present application claims priority under 35 U.S.C 119 (a) to Korean Patent Application No. 10-2024-0102015, filed on Jul. 31, 2024, which is incorporated herein by reference in its entirety.

### BACKGROUND

### 1. Field

Various embodiments of the present disclosure relate to a semiconductor device, and more particularly, to a storage system and an operating method thereof.

### 2. Discussion of the Related Art

A working memory having a small capacity and used for queues, caches or the like is provided in a nonvolatile storage system (for example, a solid-state drive (SSD)) having a cell of multiple levels (for example, quadruple-level cell (QLC)). The nonvolatile storage system needs to perform a read-back operation in a process of updating a logical-physical address map (for example, logical-to-virtual (L2V) map). During the process, the nonvolatile storage system needs to maintain the integrity of the logical-physical address map while consuming a small amount of resources of the working memory.

In the present disclosure, an SSD refers to a nonvolatile storage system. In the present disclosure, an L2V map refers to a logical-physical address map.

### SUMMARY

Various embodiments of the present disclosure are directed to providing a nonvolatile storage system, which includes a cell of multiple levels requiring a read-back operation in a process of updating a logical-physical address map and also includes a working memory of small capacity, and providing an operating method thereof, the nonvolatile storage system being capable of maintaining the integrity of the logical-physical address map while consuming a small amount of resources of the working memory.

Technical problems to be addressed in the present disclosure are not limited to the aforementioned technical problems and other unmentioned technical problems will be clearly understood by those skilled in the art from the following description.

A storage system in accordance with an embodiment of the present disclosure may include a storage device including first and second memory blocks and a controller. The controller may be configured to perform first to fourth operations. The first operation may be an operation of controlling, in response to a request, the storage device to program a requested data unit into the second memory block. The first operation may include a programming operation and a movement operation. The programming operation may be an operation of programming the requested data unit into the first memory block corresponding to a logical address included in the request and updating a mapping relationship between the logical address and a physical address indicating the first memory block. The movement operation may be an operation of moving the programmed data unit to the second memory block. The second operation may be an operation of recording the logical address and the physical address in a meta data unit corresponding to the requested data unit. The third operation may be an operation of repeating the first and second operations with respect to each of a plurality of requested data units. The fourth operation may be an operation of verifying, after the third operation, integrity of the mapping relationship for each of the moved data units based on the physical address included in each of the meta data units corresponding to the moved data units and the physical address included in the mapping relationship.

The physical address recorded in the meta data unit in the second operation may be a block address of the first memory block.

The first memory block may be a single-level cell (SLC) block, and the second memory block may be a quadruple-level cell (QLC) block.

The physical address included in the mapping relationship in the programming operation may include a block address of the first memory block.

The controller may perform the movement operation according to a valid data copy scheme of moving a single data unit from a single first memory block to the second memory block.

The controller may perform the fourth operation based on whether the physical address included in the meta data unit matches the physical address included in the mapping relationship.

The physical address included in the mapping relationship in the programming operation may further include source offset information representing offset information of the programmed data unit in the first memory block.

The controller may perform the movement operation according to a blind data copy scheme of sequentially moving a plurality of data units from a single first memory block to the second memory block.

The controller may perform the movement operation on each of the plurality of data units so that target offset information representing offset information of the moved data unit in the second memory block and the source offset information corresponding to the moved data unit have a relationship of an equation below.

$${O}_{source} = {O}_{target} mod {N}_{source \_ offsets} \qquad [ Equation ]$$

In the above equation, “O_{source}” represents the source offset information, “O_{target}” represents the target offset information, and “N_{source_offsets}” represents the number of offsets allowable or allowed in the first memory block.

The fourth operation may include an acquisition operation of acquiring, based on the equation and from the target offset information, the source offset information corresponding to the moved data unit.

The controller may perform the fourth operation based on whether the physical address included in the mapping relationship matches a combination of the physical address included in the meta data unit and the source offset information acquired in the acquisition operation.

Each of the first and second memory blocks may be a quadruple-level cell (QLC) block.

The physical address included in the mapping relationship in the programming operation may include a block address of the first memory block and source offset information representing offset information of the programmed data unit in the first memory block.

The controller may perform the movement operation on each of the plurality of data units so that target offset information representing offset information of the moved data unit in the second memory block is identical to the source offset information corresponding to the moved data unit.

The fourth operation may include an acquisition operation of acquiring, from the target offset information, the source offset information corresponding to the moved data unit.

The controller may perform the fourth operation based on whether the physical address included in the mapping relationship matches a combination of the physical address included in the meta data unit and the source offset information acquired in the acquisition operation.

The storage device may further include a working memory. The second operation may include a temporary storage operation and a recording operation. The temporary storage operation may be an operation of temporarily storing the logical address and the physical address in the working memory. The recording operation may be an operation of recording the temporarily stored logical address and physical address into a metadata unit corresponding to the requested data unit.

The second operation may further include a deletion operation of deleting, after the recording operation, the temporarily stored logical address and physical address from the working memory.

The controller may perform the third operation on a predetermined number or rows included in the second memory block and may subsequently perform the fourth operation when the controller reads the data unit moved to the second memory block and determines the read data unit to include no error.

An operating method of a controller in accordance with an embodiment of the present disclosure may include a control operation, a meta operation and a verification operation. The control operation may be an operation of controlling, in response to a request, a storage device to program a requested data unit into a second memory block. The control operation may include a programming operation and a movement operation. The programming operation may be an operation of programming the requested data unit into a first memory block corresponding to a logical address included in the request and updating a mapping relationship between the logical address and a physical address indicating the first memory block. The movement operation may be an operation of moving the programmed data unit to the second memory block. The meta operation may be an operation of recording the logical address and the physical address in a meta data unit corresponding to the requested data unit. The verification operation may be an operation of verifying integrity of the mapping relationship for the moved data unit based on the physical address included in the meta data unit corresponding to the moved data unit and the physical address included in the mapping relationship.

The first memory block may be a single-level cell (SLC) block, and the second memory block may be a quadruple-level cell (QLC) block.

The movement operation may be performed according to a valid data copy scheme of moving a single data unit from a single first memory block to the second memory block.

The verification operation may be performed based on whether the physical address included in the meta data unit matches the physical address included in the mapping relationship.

The physical address included in the mapping relationship in the programming operation may further include source offset information representing offset information of the programmed data unit in the first memory block.

The movement operation may be performed according to a blind data copy scheme of sequentially moving a plurality of data units from a single first memory block to the second memory block.

The movement operation may be performed on each of the plurality of data units so that target offset information representing offset information of the moved data unit in the second memory block and the source offset information corresponding to the moved data unit have a relationship of an equation below.

$${O}_{source} = {O}_{target} mod {N}_{source \_ offsets} \qquad [ Equation ]$$

In the above equation, “O_{source}” represents the source offset information, “O_{target}” represents the target offset information, and “N_{source_offsets}” represents the number of offsets allowable or allowed in the first memory block.

The verification operation may include an acquisition operation of acquiring, based on the equation and from the target offset information, the source offset information corresponding to the moved data unit.

The verification operation may be performed based on whether the physical address included in the mapping relationship matches a combination of the physical address included in the meta data unit and the source offset information acquired in the acquisition operation.

Each of the first and second memory blocks may be a quadruple-level cell (QLC) block.

The physical address included in the mapping relationship in the programming operation may include a block address of the first memory block and source offset information representing offset information of the programmed data unit in the first memory block.

The movement operation may be performed on each of the plurality of data units so that target offset information representing offset information of the moved data unit in the second memory block is identical to the source offset information corresponding to the moved data unit.

The verification operation may include an acquisition operation of acquiring, from the target offset information, the source offset information corresponding to the moved data unit.

The verification operation may be performed based on whether the physical address included in the mapping relationship matches a combination of the physical address included in the meta data unit and the source offset information acquired in the acquisition operation.

The meta operation may include a temporary storage operation and a recording operation. The temporary storage operation may be an operation of temporarily storing the logical address and the physical address in a working memory. The recording operation may be an operation of recording the temporarily stored logical address and physical address into a metadata unit corresponding to the requested data unit.

The meta operation may further include a deletion operation of deleting, after the recording operation, the temporarily stored logical address and physical address from the working memory.

The operating method may further include a repetition operation between the meta operation and the verification operation. The repetition operation may be an operation of repeating the control operation and the meta operation with respect to each of a plurality of requested data units. The repetition operation may be performed on a predetermined number or rows included in the second memory block. Subsequently, the verification operation may be performed when the data unit moved to the second memory block is read and the read data unit is determined to include no error.

A storage system in accordance with an embodiment of the present disclosure may include a storage device and a controller. The storage device may include first and second memory blocks. The controller may be configured to perform a control operation, a meta operation and a verification operation. The control operation may be an operation of controlling, in response to a request, the storage device to program a requested data unit into the second memory block. The control operation may include a programming operation and a movement operation. The programming operation may be an operation of programming the requested data unit into the first memory block corresponding to a logical address included in the request and updating a mapping relationship between the logical address and a physical address indicating the first memory block. The movement operation may be an operation of moving the programmed data unit to the second memory block. The meta operation may be an operation of recording the logical address and the physical address in a meta data unit corresponding to the requested data unit. The verification operation may be an operation of verifying integrity of the mapping relationship for the moved data unit based on the physical address included in the meta data unit corresponding to the moved data unit and the physical address included in the mapping relationship.

The first memory block may be a single-level cell (SLC) block and the second memory block may be a quadruple-level cell (QLC) block.

The controller may perform the movement operation according to a valid data copy scheme of moving a single data unit from a single first memory block to the second memory block.

The controller may perform the verification operation based on whether the physical address included in the meta data unit matches the physical address included in the mapping relationship.

The physical address included in the mapping relationship in the programming operation may include source offset information representing offset information of the programmed data unit in the first memory block.

The controller may perform the movement operation according to a blind data copy scheme of sequentially moving a plurality of data units from a single first memory block to the second memory block.

The controller may perform the movement operation on each of the plurality of data units so that target offset information representing offset information of the moved data unit in the second memory block and the source offset information corresponding to the moved data unit have a relationship of an equation below.

$${O}_{source} = {O}_{target} mod {N}_{source \_ offsets} \qquad [ Equation ]$$

In the above equation, “O_{source}” represents the source offset information, “O_{target}” represents the target offset information and “N_{source_offsets}” represents a number of offsets allowable or allowed in the first memory block.

The verification operation may include an acquisition operation of acquiring, based on the equation and from the target offset information, the source offset information corresponding to the moved data unit.

The controller may perform the verification operation based on whether the physical address included in the mapping relationship matches a combination of the physical address included in the meta data unit and the source offset information acquired in the acquisition operation.

The storage device may further include a working memory. The meta operation may include a temporary storage operation and a recording operation. The temporary storage operation may be an operation of temporarily storing the logical address and the physical address in the working memory. The recording operation may be an operation of recording the temporarily stored logical address and physical address into a metadata unit corresponding to the requested data unit.

The meta operation may further include a deletion operation of deleting, after the recording operation, the temporarily stored logical address and physical address from the working memory.

The controller may be further configured to perform, between the meta operation and the verification operation, a repetition operation of repeating the control operation and the meta operation with respect to each of a plurality of requested data units. The controller may perform the repetition operation on a predetermined number or rows included in the second memory block and may subsequently perform the verification operation when the controller reads the data unit moved to the second memory block and determines that the read data unit to include no error.

Embodiments of the present disclosure can provide a nonvolatile storage system, which includes a cell of multiple levels requiring a read-back operation in a process of updating a logical-physical address map and also includes a working memory of small capacity, and providing an operating thereof, the nonvolatile storage system being capable of maintaining the integrity of the logical-physical address map while consuming a small amount of resources of the working memory.

### BRIEF DESCRIPTION OF THE DRAWINGS

FIG. 1 is a diagram illustrating a program operation for a target QLC block and an update operation of an L2V map in accordance with the related art.

FIG. 2 is a diagram illustrating a metadata format for data programmed into a target QLC block in accordance with the related art.

FIG. 3 is a diagram illustrating a process of checking whether the integrity of an L2V map is maintained for data programmed into a target QLC block in accordance with an embodiment of the present disclosure.

FIG. 4 is a diagram illustrating another process of checking whether the integrity of an L2V map is maintained for data programmed into a target QLC block in accordance with an embodiment of the present disclosure.

FIG. 5 is a diagram illustrating a program operation for a target QLC block and an update operation of an L2V map in accordance with an embodiment of the present disclosure.

FIG. 6 is a diagram illustrating a metadata format for data programmed into a target QLC block in accordance with an embodiment of the present disclosure.

FIG. 7 is a diagram illustrating a process of checking whether the integrity of an L2V map is maintained for data programmed into a target QLC block in the case of a blind data copy scheme in accordance with an embodiment of the present disclosure.

FIG. 8 is a diagram illustrating a process of checking whether the integrity of an L2V map is maintained for data moved from a source QLC block and programmed into a target QLC block in accordance with an embodiment of the present disclosure.

FIG. 9 is a block diagram illustrating a nonvolatile storage system in accordance with an embodiment of the present disclosure.

### DETAILED DESCRIPTION

Embodiments of the present disclosure are described in detail below with reference to the accompanying drawings. The embodiments of the present disclosure are ones provided to make those skilled in the art to more completely understand the present disclosure. Since the embodiments of the present disclosure can be implemented in various embodiments, the present disclosure illustrates and describes specific embodiments in the drawings. However, this is not intended to limit the present disclosure to a specific embodiment disclosed and should be understood to include all changes, equivalents, and substitutes included in the spirit and technical scope of the present disclosure. When describing each drawing, similar reference numerals are used for similar components. In the accompanying drawings, the dimensions of the structures are enlarged or reduced from the actual size in order to ensure the clarity of the present disclosure.

The terms used in the present disclosure are merely used to describe specific embodiments and are not intended to limit the present disclosure. Singular expressions include plural expressions unless the context clearly dictates otherwise. In this application, terms such as “comprises” or “has” are intended to designate the presence of features, numbers, steps, operations, components, parts, or combinations thereof described in the specification, and should be understood as not excluding the presence or addition of one or more other features, numbers, steps, operations, components, parts or combinations thereof.

Terms such as first and second may be used to describe various components, but the components should not be limited by the above terms. The above terms may be used to distinguish one component from another component. For example, a first component may be referred to as a second component and similarly, the second component may also be referred to as a first component without departing from the scope of the present disclosure.

Unless otherwise defined, all terms used herein, including technical or scientific terms, have the same meaning as commonly understood by a person of ordinary skill in the technical field to which the present disclosure pertains. Terms such as those defined in generally used dictionaries should be interpreted as having meanings consistent with the meanings of the relevant technology in the context, and unless clearly defined in the present disclosure, should not be interpreted in an idealized or overly formal sense.

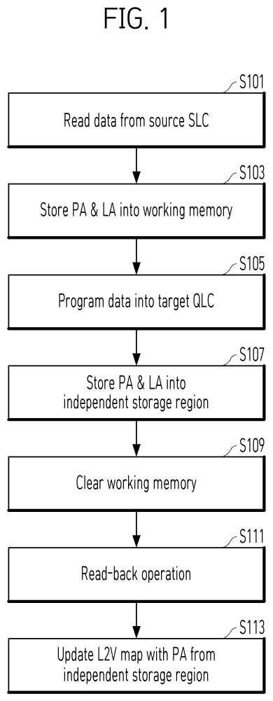

FIG. 1 is a diagram illustrating a program operation for a target quadruple-level cell (QLC) block and an update operation of an L2V map in accordance with the related art.

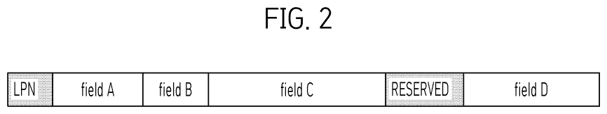

FIG. 2 is a diagram illustrating a metadata format for data programmed into the target QLC block in accordance with the related art.

A process illustrated in FIG. 1 begins with a host data unit programmed into a source single-level cell (SLC) block. Whenever the host data unit is programmed into the source SLC block, mapping information is recorded in the L2V map. The mapping information represents a logical address LA assigned to the host data unit and a source physical address PA indicating the source SLC block.

Referring to FIG. 1, in operation S101, a controller controls a nonvolatile memory device to read, from the source SLC block, data to be programmed into a target QLC block.

In operation S103, the controller temporarily stores, in a working memory, the source PA information on the read data, that is, PA information indicating the source SLC block and corresponding LA information.

In operation S105, the controller controls the nonvolatile memory device to program the read data into the target QLC block.

When the programming of the read data into the target QLC block is completed, the controller in operation S107 controls the nonvolatile memory device to store, in a separate storage space, the source PA information and the LA information temporarily stored in the working memory.

Referring to FIG. 2, metadata in accordance with the related art includes LA information (indicated by “LPN” in FIG. 2) associated with data programmed into the target QLC block. But the LA information does not include the source PA information indicating the source SLC block. That is, the source PA information of the data programmed into the target QLC block is stored not in a storage space, in which the metadata is stored, but in a separate storage space within a storage area of the nonvolatile memory device.

Referring back to FIG. 1, in operation S109, the controller deletes, from the working memory, the temporarily stored source PA information and LA information to secure, within the working memory, a space for a subsequent QLC program operation.

After program operations are performed on a predetermined number of rows (for example, QLC cells connected to a predetermined number of word lines) included in the target QLC block, the controller in operation S111 performs a read-back operation of reading the data programmed into the target QLC block.

When no error exists in the data read through the read-back operation of operation S111, the controller updates the L2V map in operation S113. Based on the source PA information stored in the separate storage space, the controller updates the L2V map for the data programmed into the target QLC block. In a case where the same LA is assigned to different host data units provided to the nonvolatile storage system at staggered times while the different host data units are respectively programmed into source SLC blocks represented by different source PAs, the integrity of the L2V map may be maintained only when, in the L2V map, the LA is mapped with the source PA indicating the source SLC block in which a later provided data unit is stored among the different host data units, that is, the latest source PA among the different source PAS. In the present disclosure, the L2V map may comprise one or more entries, and each entry includes mapping information of an LA and a source PA corresponding to a single data unit stored in a storage area. In the present disclosure, the integrity of the L2V map means whether a data unit corresponding to an LA included in each entry is the latest one stored in a source block indicated by a source PA included in the entry.

When it is determined that the integrity of the L2V map is maintained, that is, when a data unit corresponding to an LA included in an entry included in the L2V map is determined to be the latest data unit stored in a source block indicated by a source PA included in the entry, the source PA of the entry is updated to a PA of a target QLC block in which the data unit is stored.

When it is determined that the integrity of the L2V map is not maintained, that is, when the data unit corresponding to the LA included in an entry included in the L2V map is determined not to be the latest data unit stored in the source block indicated by the source PA included in the entry, the update for the entry is skipped.

The source PA information is required in order to check whether the integrity of the L2V map is maintained for the data programmed into the target QLC block.

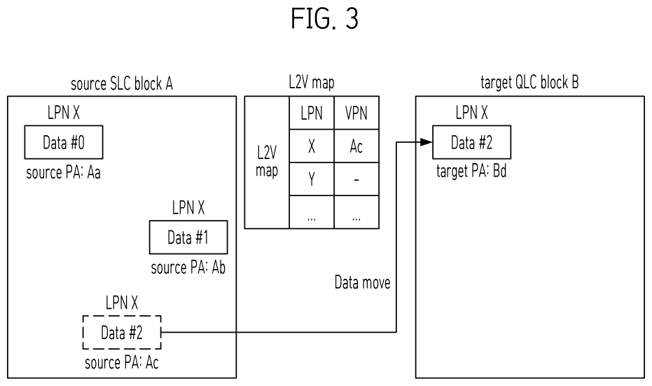

FIG. 3 illustrates a process for checking whether the integrity of an L2V map is maintained for data programmed into a target QLC block in accordance with an embodiment of the present disclosure.

FIG. 3 illustrates in which first to third data units Data #0 to #2 are sequentially programmed into a source SLC block and then programmed into the target QLC block. For example, a block address of the source SLC block is “A”. FIG. 3 illustrates an example in which (1) the first to third data units Data #0 to #2 are sequentially programmed into the source SLC block and then (2) the first to third data units Data #0 to #2 are moved from the source SLC block to the target QLC block, that is, programmed to the target QLC block.

Referring to FIG. 3, the same LA “LPN X” has been assigned to each of the first to third data units Data #0 to #2. The first to third data units Data #0 to #2 have been programmed at positions of respective source offsets “a”, “b”, and “c” within the source SLC block indicated by the block address “A”, and accordingly, the source PAS of the first to third data units Data #0 to #2 may be indicated by “Aa”, “Ab” and “Ac”, respectively.

Referring to FIG. 3, since the first to third data units Data #0 to #2 have been sequentially programmed at the positions of the source offsets “a”, “b” and “c” within the source SLC block, the source PA corresponding to the LA “LPN X” is sequentially changed to “Aa”, “Ab”, and “Ac” in the L2V map. Accordingly, when the third data unit Data #2 has been programmed into the target QLC block, the latest source PA corresponding to the LA “LPN X” included in the L2V map is “Ac”. When the latest source PA (“Ac” in this example) corresponding to the LA “LPN X” as information included in the L2V map in the operation S113 of updating the L2V map is compared with the source PA information (“Ac” in this example) stored in the separate storage space in the operation S107 for the third data unit Data #2, the latest source PA is the same as the source PA information. Accordingly, it may be determined that integrity for the LA in the L2V map is maintained. The third data unit Data #2 programmed into an area indicated by an address “Bd” in the target QLC block may be determined to be the latest data for the LA “LPN X”, and in such a case, a target PA of the L2V map for the third data unit Data #2 programmed into the area indicated by the address “Bd” is updated to “Bd”.

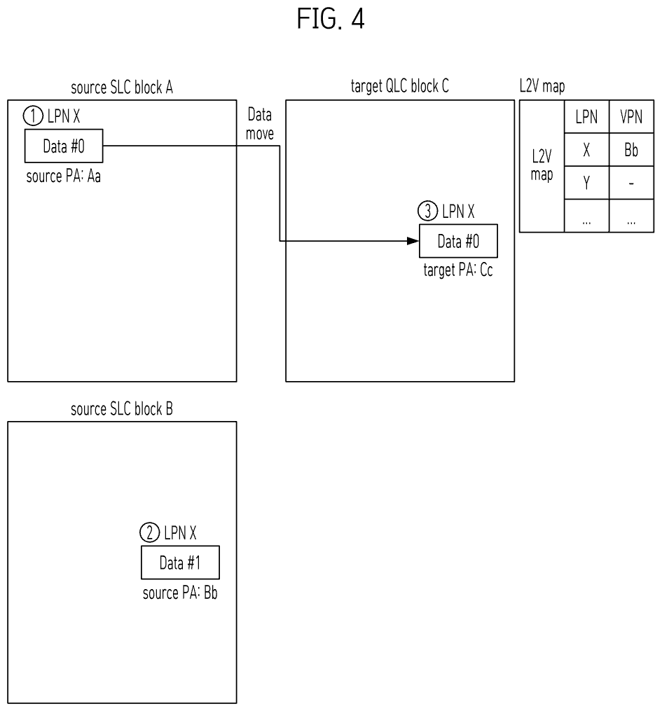

FIG. 4 illustrates another process for checking whether the integrity of the L2V map is maintained for data programmed into a target QLC block in accordance with an embodiment of the present disclosure.

FIG. 4 illustrates an example in which while the first data unit Data #0, which has been programmed into a first source SLC block (\textcircled{1}), is being programmed into the target QLC block (\textcircled{3}), the second data unit Data #1 is being programmed into a second source SLC block (\textcircled{2}). For example, a block address of the first source SLC block is “A” and the block address of the second source SLC block is “B”.

Referring to FIG. 4, the same LA “LPN X” has been assigned to each of the first and second data units Data #0 and #1. The first and second data units Data #0 and #1 have been programmed at positions of respective source offsets “a” and “b” within the source SLC blocks indicated by the respective block addresses “A” and “B”, and accordingly, the source PAs of the first and second data units Data #0 and #1 may be indicated by “Aa” and “Bb”, respectively.

Referring to FIG. 4, since the first and second data units Data #0 and #1 have been sequentially programmed into the respective source SLC blocks “A” and “B”, the source PA corresponding to the LA “LPN X” is sequentially changed to “Aa” and “Bb” in the L2V map. Accordingly, when the first data unit Data #0 has been programmed into the target QLC block, the second data unit Data #1 has already been programmed into the source SLC block indicated by the block address “B” and therefore the latest source PA corresponding to the LA “LPN X” included in the L2V map is “Bb”. When the latest source PA (“Bb” in this example) corresponding to the LA “LPN X” as information included in the L2V map in the operation S113 of updating the L2V map is compared with the source PA information (“Aa” in this example) stored in the separate storage space in the operation S107 for the first data unit Data #0, the latest source PA is different from the source PA information. Accordingly, it may be determined that integrity for the LA in the L2V map is not maintained. It is determined that the first data unit Data #0 programmed into an area indicated by an address “Cc” in the target QLC block illustrated in FIG. 4 is no longer the latest data for the LA, and in such a case, the update of the L2V map for the first data unit Data #0 programmed into the area indicated by the address “Cc” is skipped.

In accordance with an embodiment of the present disclosure, in operation S107, the source PA information of the data programmed into the target QLC block is put into metadata of the data programmed into the target QLC block without storing the source PA information in a separate storage space within the storage area, which makes it possible to determine whether the integrity of the L2V map is maintained based on a source PA included in the metadata while minimizing required resources.

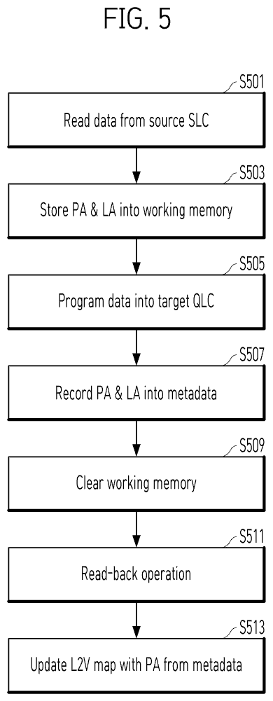

FIG. 5 is a diagram illustrating a program operation for a target QLC block and an update operation of an L2V map in accordance with an embodiment of the present disclosure.

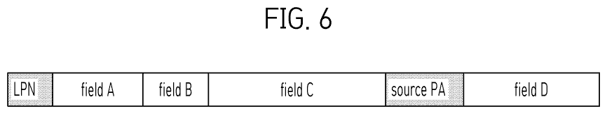

FIG. 6 is a diagram illustrating a metadata format for data programmed into a target QLC block in accordance with an embodiment of the present disclosure.

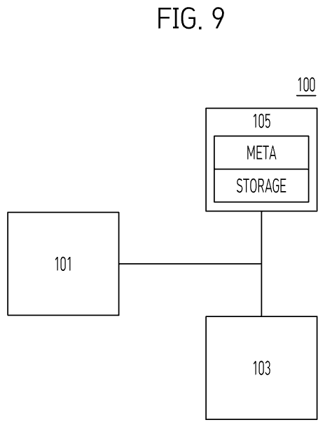

A process illustrated in FIG. 5 may begin with a host data unit programmed into a source SLC block. Whenever the host data unit is programmed into the source SLC block, mapping information may be recorded in the L2V map. The mapping information represents a logical address LA assigned to the host data unit and a source physical address PA indicating the source SLC block. A nonvolatile storage system 100 in accordance with an embodiment of the present disclosure may include a controller 101, a working memory 103, and a nonvolatile storage device 105 that are described below with reference to FIG. 9. The process illustrated in FIG. 5 may be performed by the controller 101. The source SLC block and the target QLC block may be included in a storage area of the nonvolatile storage device 105.

Referring to FIG. 5, in operation S501, the controller 101 may control the nonvolatile storage device 105 to read, from the source SLC block, data to be programmed into the target QLC block.

In operation S503, the controller 101 may temporarily store, in the working memory 103, the source PA information for the read data, that is, PA information indicating the source SLC block and corresponding LA information.

In operation S505, the controller 101 may control the nonvolatile storage device 105 to program the read data into the target QLC block.

When the programming of the read data into the target QLC block is completed, the controller 101 in operation S507 may record, in metadata of the data programmed into the target QLC block, the source PA information and the LA information temporarily stored in the working memory 103.

Referring to FIG. 6, metadata in accordance with an embodiment of the present disclosure may include LA information (indicated by “LPN” in FIG. 6) and source PA information (indicated by “source PA” in FIG. 6). The LA information may be associated with the data programmed into the target QLC block. The source PA information (indicated by “source PA” in FIG. 6) may indicate the source SLC block. That is, the source PA information as well as the LA information associated with the data programmed into the target QLC block may be stored in a storage space, in which the metadata is stored within the storage area of the nonvolatile storage device 105.

Although FIG. 5 illustrates an example in which operation S507 is performed after operation S505, the embodiment of the present disclosure is not limited to the example in FIG. 3. For example, operation S507 may be performed before operation S505.

Referring back to FIG. 5, in operation S509, the controller 101 may delete, from the working memory 103, the temporarily stored source PA information and LA information to secure, within the working memory, a space for a subsequent QLC program operation.

After program operations are performed on a predetermined number of rows (for example, QLC cells connected to a predetermined number of word lines) included in the target QLC block, the controller in operation S511 may perform a read-back operation of reading the data unit programmed into the target QLC block.

When no error exists in the data read through the read-back operation of operation S511, the controller 101 may update the L2V map in operation S513. Based on the source PA information included in the metadata of the data read through the read-back operation in operation S511, the controller 101 may update the L2V map for the data programmed into the target QLC block. In accordance with an embodiment of the present disclosure, the nonvolatile storage system performs the processes illustrated in FIGS. 3 and 4 in the same manner but can determine in operation S507 whether the integrity of the L2V map is maintained based on the source PA information stored in the metadata instead of the separate storage space.

In accordance with an embodiment of the present disclosure, the source PA information included in the metadata may be sufficient as block information on the source SLC block, that is, source block information. For example, in the case illustrated in FIG. 3, the source PA information included in the metadata in operation S507 is sufficient only with “A” indicating the source SLC block, and the source offset information “a”, “b” and “c” may not be necessary. For example, in the case illustrated in FIG. 4, the source PA information included in the metadata in operation S507 is sufficient only with “A” and “B” indicating the respective source SLC blocks and the source offset information “a” and “b” may not be necessary.

On the other hand, when a host data unit is programmed into a source SLC block, source PA information included in the L2V map may include the source offset information (“a”, “b” and “c” in the example illustrated in FIG. 3 and “a” and “b” in the example illustrated in FIG. 4) together with source block information (“A” in the example illustrated in FIG. 3 and “A” and “B” in the example illustrated in FIG. 4).

However, the source PA information required in the operation S513 of determining whether integrity for the LA included in the L2V map is maintained and also required for the L2V map may be sufficient only with the source block information (“A” in the example illustrated in FIG. 3 and “A” and “B” in the example illustrated in FIG. 4) and may be sufficient further with the source offset information (“a”, “b” and “c” in the example illustrated in FIG. 3 and “a” and “b” in the example illustrated in FIG. 4) as well as the source block information (“A” in the example illustrated in FIG. 3 and “A” and “B” in the example illustrated in FIG. 4). The source PA information required in operation S513 and also required for the L2V map may vary depending on a valid data copy scheme and a blind data copy scheme to be described below.

The valid data copy scheme may be a scheme in which at most a single data unit among data units of the same LPN moves from a single source SLC block to the target QLC block as illustrated in FIGS. and 4. The single data unit may be a data unit having a size corresponding to a single entry included in the L2V map, and accordingly, mapping information of an LA and a source PA corresponding to the single data unit may be included in the L2V map as a single entry.

In the case of the valid data copy scheme, since at most a single data unit moves from a single source SLC block to the target QLC block, the source PA information required in the operation S513 of determining whether integrity for the LA included in the L2V map is maintained and also required for the L2V map may be sufficient only with the source block information (“A” in the example illustrated in FIG. and “A” and “B” in the example illustrated in FIG. 4). That is, in the case of the valid data copy scheme, the data programmed into the target QLC block may be specified only by the source block information as source PA information, and in the operation S513, a source PA required to specify the data programmed into the target QLC block may be the source block information.

The blind data copy scheme may be a scheme in which a plurality of data units are sequentially moved from a single source SLC block to a target QLC block. According to the blind data copy scheme, the plurality of data units are sequentially moved from the single source SLC block to the target QLC block while maintaining their respective offsets in operation S505, and accordingly, a target offset in the target QLC block and a source offset in the source SLC block for each of the plurality of data units moved to the target QLC block may have a relationship as expressed in the following equation.

$${O}_{source} = {O}_{target} mod {N}_{source \_ offsets} \qquad [ Equation ]$$

In the above equation, “O_{source}” represents the source offset information, “O_{target}” represents the target offset information, and “N_{source_offsets}” represents the number of offsets allowable or allowed in the source SLC block.

In the case of the blind data copy scheme, since the plurality of data units are sequentially moved from the single source SLC block to the target QLC block in operation S505, the source PA information required in the operation S513 of determining whether integrity for the LA included in the L2V map is maintained and also required for the L2V map may include the source offset information (“a”, “b” and “c” in the example illustrated in FIG. 3 and “a” and “b” in the example illustrated in FIG. 4) as well as the source block information (“A” in the example illustrated in FIG. 3 and “A” and “B” in the example illustrated in FIG. 4). That is, in the case of the blind data copy scheme, the data programmed into the target QLC block may be specified by the source block information and the source offset information as source PA information, and in the operation S513, a source PA required to specify the data programmed into the target QLC block may be the source block information and the source offset information.

The structure of the source PA information “VPN” may include information “nVsbn” on a source block (for example, the source SLC block in the examples illustrated in FIGS. 3 and 4) and source offset information “nWordline”, “nDie”, “nBpc”, “nPlane”, “nVpnOffset” in the source block. For example, “nWordline” may represent information on a word line connected to the source block, “nDie” may represent die information including memory blocks constituting a super block as the source block, “nBpc” may represent information on a memory cell included in the source block, “nPlane” may represent plane information including the source block, and “nVpnOffset” may represent source offset information of data stored in a physical page included in the source block.

In accordance with an embodiment of the present disclosure, data programmed into a target QLC block can be specified by a selective combination of the source block information and the source offset information as source PA information.

As described above, in accordance with an embodiment of the present disclosure, the source PA information included in the metadata in operation S507 may be sufficient with block information on the source SLC block, that is, source block information. On the other hand, as described above, according to the blind data copy scheme, the plurality of data units are sequentially moved from the single source SLC block to the target QLC block while maintaining their respective offsets, and accordingly, the target offset in the target QLC block and the source offset in the source SLC block for each of the plurality of data units moved to the target QLC block may have the relationship as expressed in the above equation. In addition, as described above, in the case of the blind data copy scheme, the data programmed into the target QLC block may be specified by the source offset information (“a”, “b” and “c” in the example illustrated in FIG. 3 and “a” and “b” in the example illustrated in FIG. 4) as well as the source block information (“A” in the example illustrated in FIG. 3 and “A” and “B” in the example illustrated in FIG. 4) as the source PA information. That is, in order to specify the data programmed into the target QLC block, source offset information of the data programmed into the target QLC block may be required together with the source block information, as the source PA information included in the metadata.

In accordance with an embodiment of the present disclosure, the source offset information (“a”, “b” and “c” in the example illustrated in FIG. 3 and “a” and “b” in the example illustrated in FIG. 4) can be acquired from a target PA that is location information of the data programmed into the target QLC block. The target PA may include target offset information, i.e., information of an offset within the target QLC block in which data is stored. Specifically, the source offset information can be acquired based on the modular operation shown in the above equation.

As described above, in accordance with an embodiment of the present disclosure, in the case of the blind data copy scheme, source offset information of data programmed into a target QLC block can be acquired according to the above equation based on a target PA of the data programmed into the target QLC block and a number of offsets allowable or allowed in a source SLC block. Accordingly, it can be determined in operation S513 whether integrity is maintained for the LA, which is included in the L2V map and is for the data programmed into the target QLC block.

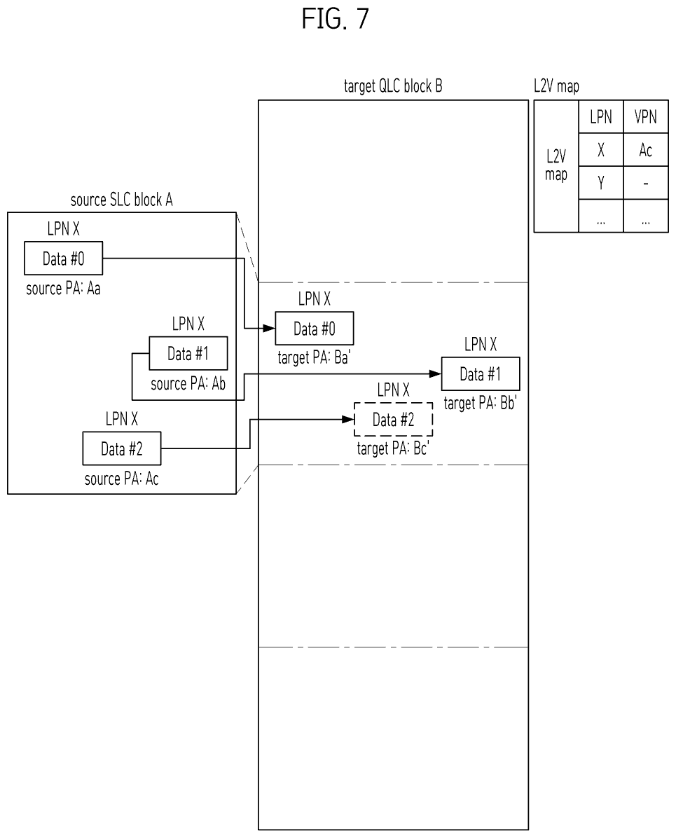

FIG. 7 illustrates a process of checking whether the integrity of an L2V map is maintained for data programmed into a target QLC block in the case of the blind data copy scheme in accordance with an embodiment of the present disclosure.

FIG. 7 illustrates an example in which first to third data units Data #0 to #2 programmed into a single source SLC block are sequentially programmed into a target QLC block according to the blind data copy scheme. For example, a block address of the source SLC block may be “A” and a block address of the target QLC block may be “B”. FIG. 7 illustrates an example in which (1) the first to third data units Data #0 to #2 are sequentially programmed into the source SLC block and then (2) the first to third data units Data #0 to #2 are moved from the source SLC block to the target QLC block, that is, programmed to the target QLC block.

Referring to FIG. 7, the same LA “LPN X” has been assigned to each of the first to third data units Data #0 to #2. The first to third data units Data #0 to #2 have been programmed at positions of respective source offsets “a”, “b” and “c” within the source SLC block indicated by the block address “A”, and accordingly, the source PAS of the first to third data units Data #0 to #2 may be indicated by “Aa”, “Ab” and “Ac”, respectively.

In addition, through operation S505, the first to third data units Data #0 to #2 have been sequentially moved to the positions of respective target offsets “a”, “b” and “c” within the target QLC block, and accordingly, the target PAs of the first to third data units Data #0 to #2 as data programmed into the target QLC block may be indicated by “Ba”, “Bb” and “Bc”, respectively. The source offsets “a”, “b” and “c” and the target offsets “a”, “b” and “c” may have the relationship of the above equation, respectively, according to the blind data copy scheme.

Referring to FIG. 7, since the first to third data units Data #0 to #2 have been sequentially programmed at the positions of the source offsets “a”, “b” and “c” within the source SLC block, the source PA corresponding to the LA “LPN X” may be sequentially changed to “Aa”, “Ab” and “Ac” in the L2V map. Accordingly, when the third data unit Data #2 has been programmed into the target QLC block, the latest source PA corresponding to the LA “LPN X” included in the L2V map may be “Ac”.

On the other hand, in operation S507, the metadata of the third data unit Data #2 programmed into the target QLC block may include the block address “A” of the source SLC block as the source PA information of the third data unit Data #2 but may not include “c” as source offset information. However, in the operation S513 of updating the L2V map, “c” as the source offset information of the third data unit Data #2 may be acquired, through the above equation, from “Bc” as the target PA of the third data unit Data #2, and accordingly, source block information and source offset information “Ac” may be acquired as the source PA information of the third data unit Data #2.

When comparing the latest source PA (“Ac” in this example) corresponding to the LA “LPN X” as information included in the L2V map in the operation S513 of updating the L2V map with the source PA information (“Ac” in this example) acquired for the third data unit Data #2, the latest source PA may be the same as the source PA information. Accordingly, it may be determined that integrity is maintained for the LA in the L2V map. The third data unit Data #2 programmed into an area indicated by an address “Bc” within the target QLC block may be determined to be the latest data for the LA “LPN X”, and in such a case, a target PA of the L2V map for the third data unit Data #2 programmed into the area indicated by the address “Bc” may be updated to “Bc”.

In an embodiment in accordance with the present disclosure described above, a source block is an SLC block; however, in accordance with an embodiment of the present disclosure, the source block may be a QLC block. In accordance with an embodiment of the present disclosure, the source PA information included in the metadata in operation S507 can be sufficient with block information on a source QLC block, that is, source block information. On the other hand, in accordance with an embodiment of the present disclosure, a plurality of data units can be sequentially moved from a single source QLC block to a target QLC block while maintaining their respective offsets, and accordingly, a target offset in the target QLC block may be the same as a source offset in the source QLC block with respect to each of the plurality of data units moved to the target QLC block. In addition, in accordance with an embodiment of the present disclosure, data programmed into the target QLC block can be specified by the source offset information (“a”, “b” and “c” in the example illustrated in FIG. 3 and “a” and “b” in the example illustrated in FIG. 4) as well as the source block information (“A” in the example illustrated in FIG. 3 and “A” and “B” in the example illustrated in FIG. 4), as source PA information. That is, in order to specify the data programmed into the target QLC block, source offset information of the data programmed into the target QLC block can be required together with source block information, as source PA information included in the metadata.

In accordance with an embodiment of the present disclosure, the source offset information (“a”, “b” and “c” in the example illustrated in FIG. 3 and “a” and “b” in the example illustrated in FIG. 4) can be acquired from a target PA that is location information of the data programmed into the target QLC block. The target PA may include target offset information, i.e., information of an offset within the target QLC block in which data is stored. Specifically, since a target offset in the target QLC block is the same as a source offset in the source QLC block with respect to each of the plurality of data units moved to the target QLC block, source offset information of the data programmed into the target QLC block can be acquired based on the target PA of the data programmed into the target QLC block. Accordingly, it can be determined in operation S513 whether integrity is maintained for the LA, which is included in the L2V map and is for the data programmed into the target QLC block.

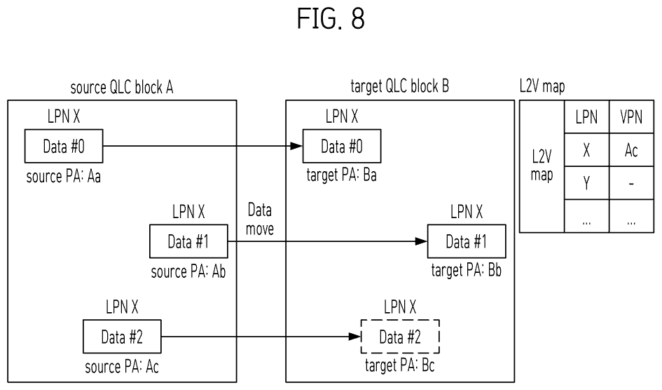

FIG. 8 illustrates a process of checking whether the integrity of an L2V map is maintained for data moved from a source QLC block and programmed into a target QLC block in accordance with an embodiment of the present disclosure.

FIG. 8 illustrates an example in which first to third data units Data #0 to #2 programmed into a single source QLC block are sequentially programmed into a target QLC block. For example, a block address of the source QLC block may be “A” and a block address of the target QLC block may be “B”. FIG. 8 illustrates an example in which the first to third data units Data #0 to #2 are sequentially programmed into the source QLC block and then the first to third data units Data #0 to #2 are moved from the source QLC block to the target QLC block, that is, programmed to the target QLC block.

Referring to FIG. 8, the same LA “LPN X” has been assigned to each of the first to third data units Data #0 to #2. The first to third data units Data #0 to #2 have been programmed at the positions of respective source offsets “a”, “b” and “c” within the source QLC block indicated by the block address “A”, and accordingly, the source PAS of the first to third data units Data #0 to #2 may be indicated by “Aa”, “Ab” and “Ac”, respectively. In addition, through operation S505, the first to third data units Data #0 to #2 have been sequentially moved to the positions of respective target offsets “a”, “b” and “c” within the target QLC block, and accordingly, the target PAs of the first to third data units Data #0 to #2 as data programmed into the target QLC block may be indicated by “Ba”, “Bb”, and “Bc”, respectively. The source offsets “a”, “b” and “c” and the target offsets “a”, “b” and “c” may have the same values, respectively.

Referring to FIG. 8, since the first to third data units Data #0 to #2 have been sequentially programmed at the positions of the source offsets “a”, “b” and “c” within the source QLC block, the source PA corresponding to the LA “LPN X” may be sequentially changed to “Aa”, “Ab” and “Ac” in the L2V map. Accordingly, when the third data unit Data #2 has been programmed into the target QLC block, the latest source PA corresponding to the LA “LPN X” included in the L2V map may be “Ac”.

On the other hand, in operation S507, the metadata of the third data unit Data #2 programmed into the target QLC block may include the block address “A” of the source QLC block as the source PA information of the third data unit Data #2 but may not include “c” as source offset information. However, in the operation S513 of updating the L2V, “c” as the source offset information of the third data unit Data #2 may be acquired from “Bc” as the target PA of the third data unit Data #2, and accordingly, source block information and source offset information “Ac” may be acquired as the source PA information of the third data unit Data #2.

When comparing the latest source PA (“Ac” in this example) corresponding to the LA “LPN X” as information included in the L2V map in the operation S113 of updating the L2V map with the source PA information (“Ac” in this example) acquired for the third data unit Data #2, the latest source PA may be the same as the source PA information. Accordingly, it may be determined that integrity is maintained for the LA in the L2V map. The third data unit Data #2 programmed into an area indicated by an address “Bc” within the target QLC block may be determined to be the latest data for the LA “LPN X”, and in such a case, a target PA of the L2V map for the third data unit Data #2 programmed into the area indicated by the address “Bc” may be updated to “Bc”.

In accordance with an embodiment of the present disclosure, in operation S107, the source PA information of the data programmed into the target QLC block is put into metadata of the data programmed into the target QLC block without storing the source PA information in a separate storage space within the storage area, which makes it possible to determine whether the integrity of the L2V map is maintained based on a source PA included in the metadata while minimizing required resources.

FIG. 9 is a block diagram illustrating the nonvolatile storage system 100 in accordance with an embodiment of the present disclosure.

Referring to FIG. 9, the nonvolatile storage system 100 may include the controller 101, the working memory 103, and the nonvolatile storage device 105. The nonvolatile storage system 100 operates in response to a request from a host and, in particular, may store data accessed by the host. The nonvolatile storage system 100 may be used as a main memory or an auxiliary memory of the host. The nonvolatile storage system 100 may be implemented with any of various types of storage devices depending on a host interface protocol connected to the host. For example, the nonvolatile storage system may be implemented with any of various types of storage devices such as a multimedia card in the form of a solid state drive (SSD), an MMC, an embedded MMC (eMMC), a reduced size MMC (RS-MMC), or a micro-MMC, a secure digital card in the form of an SD, a mini-SD, or a micro-SD, a universal serial bus (USB) storage device, a universal flash storage (UFS) device, a compact flash (CF) card, a smart media card, and a memory stick.

The nonvolatile storage system 100 may include the nonvolatile storage device 105 for storing data accessed by the host and the controller 101 for controlling the operation of the nonvolatile storage device 105.

The controller 101 and the nonvolatile storage device 105 may be integrated into a single semiconductor device. As an example, the controller 101 and the nonvolatile storage device 105 may be integrated into a single semiconductor device to form an SSD. When the nonvolatile storage system 100 is used as an SSD, the operating speed of the host connected to the nonvolatile storage system 100 may be further improved. In addition, the controller 101 and the nonvolatile storage device 105 may be integrated into a single semiconductor device to form a memory card, and to form, for example, a memory card such as a PC card (PCMCIA: personal computer memory card international association), a compact flash (CF) card, smart media cards SM and SMC, a memory stick, multimedia cards MMC, RS-MMC, and MMCmicro, SD cards SD, miniSD, microSD, and SDHC, and a universal flash storage (UFS) device.

In addition, as another example, the nonvolatile storage system may constitute a computer, an ultra mobile PC (UMPC), a workstation, a net-book, a personal digital assistants (PDA), a portable computer, a wearable device, a web tablet, a tablet computer, a wireless phone, a mobile phone, a smart phone, an e-book, a portable multimedia player (PMP), a portable game machine, a navigation device, a black box, a digital camera, a digital multimedia broadcasting (DMB) player, a three-dimensional television, a smart television, a digital audio recorder, a digital audio player, a digital picture recorder, a digital picture player, a digital video recorder, a digital video player, a storage constituting a data center, a device capable of transmitting and receiving information in a wireless environment, one of various electronic devices constituting a home network, one of various electronic devices constituting a computer network, one of various electronic devices constituting a telematics network, a radio frequency identification (RFID) device, and one of various components constituting a computing system.

The nonvolatile storage device 105 may retain stored data even though power is not supplied. In particular, the nonvolatile storage device 105 may store data provided from the host through a write operation and provide the stored data to the host through a read operation. The nonvolatile storage device 105 may include a memory cell array (not illustrated) including a plurality of memory cells that store data.

The memory cell array (not illustrated) may include a plurality of memory blocks. Each of the memory blocks may include a plurality of memory cells. A single memory block may include a plurality of pages. Depending on an embodiment, the page may be a unit for storing data in the nonvolatile storage device 105 or reading data stored in the nonvolatile storage device 105. The memory block may be a unit for erasing data.

The nonvolatile storage device 105 may be configured to receive a command and an address from the controller 101, and access an area selected by an address in the memory cell array. The nonvolatile storage device 105 may perform an operation indicated by a command with respect to the area selected by the address. For example, the nonvolatile storage device 105 may perform a program operation, a read operation, and an erase operation. During the program operation, the nonvolatile storage device 105 programs data in the area selected by the address. During the read operation, the nonvolatile storage device 105 reads data from the area selected by the address. During the erase operation, the nonvolatile storage device 105 erases data stored in the area selected by the address.

The controller 101 may control the overall operation of the nonvolatile storage system 100.

When the nonvolatile storage system 100 is powered on, the controller 101 may execute firmware. When the nonvolatile storage device 105 is a flash memory device, the firmware may include a host interface layer for controlling communication with the host, a flash conversion layer for controlling communication between the host and the nonvolatile storage device 105, and a flash interface layer for controlling communication with the nonvolatile storage device 105.

Depending on an embodiment, the controller 101 may receive data and a logical address from the host and convert the logical address into a physical address indicating an address of a memory cell in which data included in the nonvolatile storage device 105 is to be stored.

The controller 101 may control the nonvolatile storage device to perform the program operation, the read operation, the erase operation, or the like, according to a request from the host. During the program operation, the controller 101 may provide a write command, a physical address, and data to the nonvolatile storage device 105. During the read operation, the controller 101 may provide a read command and a physical address to the nonvolatile storage device 105. During the erase operation, the controller 101 may provide an erase command and a physical address to the nonvolatile storage device 105.

Depending on an embodiment, the controller 101 may independently generate commands, addresses, and data and transmit them to the nonvolatile storage device 105 regardless of requests from the host. For example, the controller 101 may provide the nonvolatile storage device 105 with commands, addresses, and data for performing a read operation and a program operation involved in performing wear leveling, read reclaim, garbage collection, or the like.

Depending on an embodiment, the controller 101 may control two or more nonvolatile storage devices 105. In such a case, the controller 101 may control the nonvolatile storage device 105 according to an interleaving method in order to improve operating performance. The interleaving method is a method for controlling the operations of at least two nonvolatile storage devices 105 to overlap.

The host may communicate with the nonvolatile storage system by using at least one of various communication standards or interfaces such as a universal serial bus (USB), a serial AT attachment (SATA), a serial attached SCSI (SAS), a high-speed inter-chip (HSIC), a small computer system interface (SCSI), a peripheral component interconnection (PCI), a PCI express (PCIe), a non-volatile memory express (NVMe), a universal flash storage (UFS), a secure digital (SD), a multi-media card (MMC), an embedded MMC (eMMC), a dual in-line memory module (DIMM), a registered DIMM (RDIMM), and a load reduced DIMM (LRDIMM).

The controller 101 may control the working memory 103 and the nonvolatile storage device 105 to perform the processes described with reference to FIGS. 5 to 8. For example, the controller 101 may control the working memory 103 and the nonvolatile storage device 105 to perform the process described with reference to FIG. 5. For example, the metadata described with reference to FIG. 6 may be data programmed into or read from the meta area META. The source SLC and/or QLC block and the target QLC block may be included in the storage area STORAGE of the nonvolatile storage device 105. The controller 101 may control the nonvolatile storage device 105 to perform a program operation and a read operation on the source SLC and/or the QLC block and the target QLC block.

The controller 101 may generate, change or delete the entry included in the L2V map.

The controller 101 in operation S503 may temporarily store, in the working memory 103, the source PA information and corresponding LA information for the data read from the source SLC block in operation S501.

The controller 101 in operation S507 may store, in the meta area META, the source PA information and the LA information, which are temporarily stored in the working memory 103 in operation S503, as metadata of the data programmed into the target QLC block in operation S505.

The controller 101 in operation S509 may control the temporarily stored source PA information and LA information to be deleted from the working memory 103.

The controller 101 in operation S511 may control the nonvolatile storage device 105 to perform the read-back operation.

The controller 101 may update the L2V map in operation S513.

The controller 101 may perform the process described with reference to FIGS. 5 to 8 according to the valid data copy scheme and the blind data copy scheme.

The working memory 103 may be a volatile memory device.

The embodiments of the present disclosure described above are not limited by the aforementioned embodiments and the accompanying drawings, and it will be apparent to those skilled in the art to which the present disclosure pertains that various replacements, modifications, and changes can be made without departing from the technical spirit of the present disclosure. Furthermore, the embodiments may be combined to form additional embodiments.

What is claimed is:

1. A storage system comprising:
a storage device including first and second memory blocks; and
a controller configured to perform:
a control operation of controlling, in response to a request, the storage device to program a requested data unit into the second memory block, the control operation including a programming operation and a movement operation, the programming operation being an operation of programming the requested data unit into the first memory block corresponding to a logical address included in the request and updating a mapping relationship between the logical address and a physical address indicating the first memory block, and the movement operation being an operation of moving the programmed data unit to the second memory block,
a meta operation of recording the logical address and the physical address in a meta data unit corresponding to the requested data unit, and
a verification operation of verifying integrity of the mapping relationship for the moved data unit based on the physical address included in the meta data unit corresponding to the moved data unit and the physical address included in the mapping relationship.

2. The storage system of claim 1, wherein the first memory block is a single-level cell (SLC) block and the second memory block is a quadruple-level cell (QLC) block.

3. The storage system of claim 2, wherein the controller performs the movement operation according to a valid data copy scheme of moving a single data unit from a single first memory block to the second memory block.

4. The storage system of claim 3, wherein the controller performs the verification operation based on whether the physical address included in the meta data unit matches the physical address included in the mapping relationship.

5. The storage system of claim 2, wherein the physical address included in the mapping relationship in the programming operation includes source offset information representing offset information of the programmed data unit in the first memory block.

6. The storage system of claim 5, wherein the controller performs the movement operation according to a blind data copy scheme of sequentially moving a plurality of data units from a single first memory block to the second memory block.

7. The storage system of claim 6, wherein the controller performs the movement operation on each of the plurality of data units so that target offset information representing offset information of the moved data unit in the second memory block and the source offset information corresponding to the moved data unit have a relationship of an equation below.
$${O}_{source} = {O}_{target} mod {N}_{source \_ offsets} , \qquad [ Equation ]$$
where
“O_{source}” represents the source offset information, “O_{target}” represents the target offset information and “N_{source_offsets}” represents a number of offsets allowable or allowed in the first memory block.

8. The storage system of claim 7, wherein the verification operation includes an acquisition operation of acquiring, based on the equation and from the target offset information, the source offset information corresponding to the moved data unit.

9. The storage system of claim 8, wherein the controller performs the verification operation based on whether the physical address included in the mapping relationship matches a combination of the physical address included in the meta data unit and the source offset information acquired in the acquisition operation.

10. The storage system of claim 1,
wherein the storage device further includes a working memory, and
wherein the meta operation includes:
a temporary storage operation of temporarily storing the logical address and the physical address in the working memory; and
a recording operation of recording the temporarily stored logical address and physical address into a metadata unit corresponding to the requested data unit.

11. The storage system of claim 10, wherein the meta operation further includes a deletion operation of deleting, after the recording operation, the temporarily stored logical address and physical address from the working memory.

12. The storage system of claim 1,
wherein the controller is further configured to perform, between the meta operation and the verification operation, a repetition operation of repeating the control operation and the meta operation with respect to each of a plurality of requested data units, and
wherein the controller performs the repetition operation on a predetermined number or rows included in the second memory block and subsequently performs the verification operation when the controller reads the data unit moved to the second memory block and determines that the read data unit to include no error.

13. An operating method of a controller, the operating method comprising:
a control operation of controlling, in response to a request, a storage device to program a requested data unit into a second memory block, the control operation including a programming operation and a movement operation, the programming operation being an operation of programming the requested data unit into a first memory block corresponding to a logical address included in the request and updating a mapping relationship between the logical address and a physical address indicating the first memory block, and the movement operation being an operation of moving the programmed data unit to the second memory block;
a meta operation of recording the logical address and the physical address in a meta data unit corresponding to the requested data unit; and
a verification operation of verifying integrity of the mapping relationship for the moved data unit based on the physical address included in the meta data unit corresponding to the moved data unit and the physical address included in the mapping relationship.

14. The operating method of claim 13, wherein each of the first and second memory blocks is a quadruple-level cell (QLC) block.

15. The operating method of claim 14, wherein the physical address included in the mapping relationship in the programming operation includes a block address of the first memory block and source offset information representing offset information of the programmed data unit in the first memory block.

16. The operating method of claim 15, wherein the movement operation is performed on each of a plurality of data units so that target offset information representing offset information of the moved data unit in the second memory block is identical to the source offset information corresponding to the moved data unit.

17. The operating method of claim 16, wherein the verification operation includes an acquisition operation of acquiring, from the target offset information, the source offset information corresponding to the moved data unit.

18. The operating method of claim 17, wherein the verification operation is performed based on whether the physical address included in the mapping relationship matches a combination of the physical address included in the meta data unit and the source offset information acquired in the acquisition operation.
